(19) United States
(12) Patent Application Publication
(10) Pub. No.: US 2016/0159426 A1
(43) Pub. Date: Jun. 9, 2016

(54) Vibration-damping handlebar assembly

(71) Applicant: Sam Malaj, Plymouth, WI (US)

(72) Inventor: Sam Malaj, Plymouth, WI (US)

(21) Appl. No.: 14/962,262

(22) Filed: Dec. 8, 2015

Related U.S. Application Data
(60) Provisional application No. 62/088,879, filed on Dec. 8, 2014.

(51) Int. Cl. B62K 21/12; B62K 21/26

(52) U.S. Cl. CPC B62K 21/125; B62K 21/26

(57) ABSTRACT

Motorized vehicles such as motorcycles, which utilize handlebars for control, exhibit a significant problem in that they transmit engine and road vibrations through the handlebars to the operator which can cause numbness, tingling and nerve damage under long-term exposure.

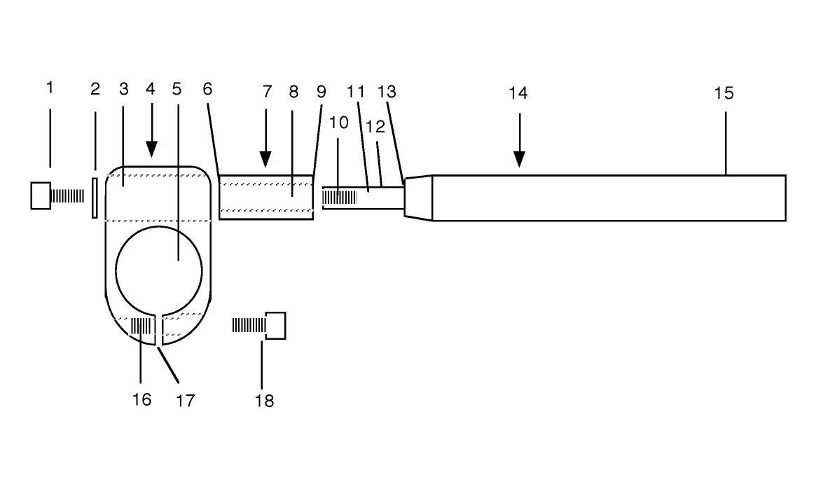

This application claims priority of Provisional Application No. 62/088,879 filed Dec. 08, 2014.

A vibration-damping handlebar assembly (VDHA) that is used in combination with a motorcycle fork assembly. The VDHA is comprised of a bar (14), a damper (7) and a receiver (4). Bar (14) having a first end (12), a second end (15) and a shoulder (13) is inserted into the inner surface (8) of damper (7) with shouldered section (11). Damper (7) having a first end (6), an inner surface (8) and a second end (9) wherein second end (9) meets with shoulder (13). Damper (7) is in-turn inserted into the bore (3) of receiver (4). Receiver (4) having a first bore (3) and a second bore (5) with a relief (17) is in-turn mounted to the upper end of motorcycle fork by inserting upper motorcycle fork into second bore (5). Receiver (4) is securely affixed to motorcycle fork by tightening bolt (18) through threaded hole (16) wherein tightening bolt (18) causes bore (5) to compress securely around upper motorcycle fork by compressing relief (17). Bar (14) and damper (7) are secured into bore (3) by compressing damper (7) within bore (3) by tightening bolt (1) through washer (2) which meets with damper's first end (6) causing compression of damper (7) when bolt (1) is threaded and tightened into hole (10).

### TECHNICAL FIELD

The invention generally pertains to vibration damping systems, and more particularly to a vibration-damping handlebar assembly that is specially designed for use on two-wheeled vehicles such as motorcycles equipped with clip-on handlebars, which are mounted to the upper fork of a motorcycle.

### BACKGROUND ART

Motorcycle handlebars can be categorized into two primary types: 1) a single bar that runs from the left hand to the right hand which is in-turn mounted to a motorcycle's upper triple clamp at the midsection of the bar by way of two risers and 2) a pair of bar assemblies in which each bar assembly clamps to the top of each individual fork leg, otherwise known in the motorcycle industry as “clip-on” handlebars, commonly found on racing type motorcycles. Clip-on type handlebars are used to facilitate a lower riding position with a lower grip position that riser type handlebars cannot accommodate.

There have been many attempts to reduce vibrations in handlebars by way of tuned-mass harmonic resonance dampers. These implements do not isolate vibrations from the operator's hands. Rather, they merely offset some of the vibrations based on how the implement's mass counter-vibrates against the inherent engine vibration at a given engine RPM or engine vibration frequency. The result is that only a narrow range of engine frequencies within a narrow RPM range become counterbalanced because these counterbalancing implements cannot be mass tuned for every given engine vibration frequency, intensity or RPM.

While there does exist a means for rubber mounting a single-bar riser type handlebar wherein the risers of this type of handlebar are rubber mounted to the upper triple clamp of the motorcycle, there did not exist any such means for rubber mounting or isolating clip-on type handlebars from engine vibrations prior to the instant invention.

A prior art search did not disclose literature or patents that read directly on the claims of the instant invention.

1. A vibration-damping, clip-on handlebar assembly, used to steer a motorcycle. Handlebar assembly is comprised of a bar having a first end, a second end and a shoulder; an elastomeric damper and a receiver, wherein said handlebar assembly dampens engine vibrations to the operator's hands by means of isolating said bar from said receiver; and attachment means for securely maintaining said bar within said receiver.

2. Wherein the attachment means is comprised of an elastomeric insert that is either bonded within said receiver or compressed within said receiver by means of a fastener that fastens into end of said bar which compresses said damper within the bore of said receiver, wherein said bar and damper are held within the bore of said receiver and said handlebar is suspended therein by compression fit.
a) A vibration-damping, clip-on handlebar assembly that is used in combination with a motorcycle fork, wherein said assembly is comprised of:
b) a bar having a mesial end and a distal end, said mesial end having a shouldered section,
c) a damper sleeve wherein the shouldered section of said bar is inserted into the inner area of said sleeve,
d) a receiver with a bore wherein said damper/bar subassembly is in-turn inserted into the bore and attached to the bore of said receiver, said receiver also being the means by which said handlebar assembly attaches to motorcycle fork as to allow said assembly to control the motorcycle.

3. The handlebar assembly as specified in claim 1 wherein said handlebar assembly is used on a powered two-wheeled vehicle that is selected from the group consisting of a motorcycle, a dirt bike, an all-terrain vehicle (ATV), and a bicycle.

4. The bar is made of a material that is selected from the group consisting of metal, plastic, and carbon fiber.

5. The damper sleeve is made of a material that is selected from the group consisting of rubber, elastomer and plastic.

6. The receiver is made of a material that is selected from the group consisting of metal, plastic, and carbon fiber.

7. The vibration damping handlebar assembly as specified in claim 2 wherein said bar and said damper are frictionally held within the bore of said receiver.

8. The vibration damping handlebar assembly as specified in claim 2 wherein said bar and said damper are bonded, fused or glued within the bore of said receiver.

9. The vibration damping handlebar assembly attaches by clamping to the fork of a motorcycle.

10. The vibration damping handlebar assembly is in-turn fastened to a separate clamp, which is clamped to the fork of the motorcycle, wherein said assembly can be adjusted for height and/or tilt on said clamp.
